(19) United States
(12) Patent Application Publication
(10) Pub. No.: US 2018/0237161 A1
(43) Pub. Date: Aug. 23, 2018

(54) SYSTEMS AND METHODS FOR UAV DOCKING AND RECHARGING

(71) Applicant: Echostar Technologies L.L.C., Englewood, CO (US)

(72) Inventors: Danny J. Minnick, Castle Rock, CO (US); Jordan Goldey, Castle Pines, CO (US); Kyle Michel, Portland, OR (US); Samuel DeWhitt, Happy Valley, OR (US); Kevin Jones, Portland, OR (US); Jessica Mann, Portland, OR (US)

(21) Appl. No.: 15/438,484

(22) Filed: Feb. 21, 2017

(51) Int. Cl. B64F 5/00; B64C 39/02; B64D 47/08; B60L 11/18

(52) U.S. Cl. CPC B64F 5/00; B64C 39/024; B64D 47/08; B60L 11/1816; B60L 11/1833; B60L 11/1835; B60L 2200/10; B64C 2201/042; B64C 2201/18; B64C 2201/027; B64C 2201/141; B64C 2201/146; B60L 11/1862

(57) ABSTRACT

Various arrangements for charging an unmanned aerial vehicle (UAV) may be presented. When flying in the vicinity of the UAV docking station, the UAV may identify the UAV docking station based on image recognition of an alignment graphic on a docking platform of the UAV docking station. The UAV may then determine a landing rotational orientation based on the image recognition. The UAV may rotate to the landing rotational orientation. The UAV may land on the docking platform of the UAV docking station in the landing rotational orientation such that electrical contacts of the UAV electrically connect with electrical contacts of the UAV docking station.

### CROSS REFERENCE TO RELATED APPLICATIONS

U.S. patent application Ser. No. 14/982,366, filed Dec. 29, 2015, attorney docket number P2015-01-10 (0931199), entitled “Unmanned Aerial Vehicle Integration with Home Automation Systems,” is hereby incorporated by reference for all purposes. U.S. patent application Ser. No. 15/228,672, filed Aug. 4, 2016, attorney docket number P2016-01-03 (0970716), entitled “Midair Tethering of an Unmanned Aerial Vehicle with a Docking Station,” is also hereby incorporated by reference for all purposes.

### BACKGROUND

For a battery-powered unmanned aerial vehicle (UAV), also referred to as a drone, to be recharged, typically it must be plugged into a recharging device or have a battery pack removed and temporarily coupled with a recharging device. This set up typically requires a user to manually plug a cable or charging device into the UAV or a battery of the UAV. If a UAV is going to be used for occasional or periodic (e.g., hourly, daily) tasks, such as patrolling in or around a user's home, requiring the user to manually couple the UAV or the UAV's battery with a recharging device may be inefficient and inconvenient to the user. Rather, a system that can autonomously dock a UAV for recharging would allow for an improved ability to operate a UAV independent of a user.

### SUMMARY

Various arrangements for an unmanned aerial vehicle docking system are presented. In some embodiments a UAV docking system can include a UAV that includes a propulsion system, an on-board power storage component, a support structure, a first plurality of electrical contacts electrically connected with the on-board power storage component and attached with a lower portion of the support structure. The system may further include a UAV docking station that includes a landing platform upon which the UAV lands, a second plurality of electrical contacts positioned on the landing platform such that the first plurality of electrical contacts of the UAV physically contact the second plurality of electrical contacts when the UAV has landed upon the landing platform, and a power source that supplies power to at least one electrical contact of the second plurality of electrical contacts.

Embodiments of such a system may include one or more of the following features: The UAV docking station may include a visual alignment pattern on the landing platform. The UAV may include an imaging sensor that is positioned on the UAV to image a field-of-view below the support structure of the UAV. The UAV may include an imaging processor that receives imaging data from the imaging sensor, wherein imaging processor is configured to control the propulsion system of the UAV to rotationally align the UAV with respect to the visual alignment pattern on the landing platform of the UAV docking station. The visual alignment pattern may include a plurality of colored patches. The first plurality of electrical contacts may include: a UAV power electrical contact, a UAV ground electrical contact, and a UAV signal electrical contact. The second plurality of electrical contacts may include a docking station power electrical contact, a docking station ground electrical contact, and a docking station signal electrical contact. The UAV docking station may include an engagement circuit that electrically connects and electrically disconnects the second plurality of contacts from the power source of the UAV docking system. The support structure may include a first rail and a second rail, wherein the first rail is parallel to the second rail. At least a first electrical contact and a second electrical contact of the first plurality of electrical contacts may be attached with the first rail such that when the UAV is positioned on the UAV docking station, the first electrical contact and the second electrical contact of the first plurality of electrical contacts physically contact a first electrical contact and a second electrical contact of the second plurality of electrical contacts. The docking station may further include a battery charge monitor that occasionally performs a measurement of an electrical condition of the on-board power storage component of the UAV. The battery charge monitor may be configured to enable and disable charging of the on-board power storage component by the power source of the UAV docking station based on the measurement of the electrical condition while the UAV is positioned on the landing platform. The on-board power storage component may be charged without any direct physical manipulation by a person.

In some embodiments, a UAV docking apparatus is present that includes a UAV. The UAV may include a propulsion system; an on-board power storage component; a support structure; and a first plurality of electrical contacts electrically connected with the on-board power storage component and attached with a lower portion of the support structure. The UAV may further include an imaging sensor that is positioned on the UAV to image a field-of-view below the support structure; and an imaging processor that receives imaging data from the imaging sensor, wherein imaging processor is configured to control the propulsion system of the UAV to rotationally align the UAV with respect to a visual alignment pattern on a landing surface of a UAV docking station.

Embodiments of such a docking apparatus may include one or more of the following features: The support structure may include a first rail and a second rail, wherein the first rail is parallel to the second rail. At least a first electrical contact and a second electrical contact of the first plurality of electrical contacts may be attached with the first rail such that when the UAV is positioned on the UAV docking station, the first electrical contact and the second electrical contact of the first plurality of electrical contacts physically contact a first electrical contact and a second electrical contact of the second plurality of electrical contacts.

In some embodiments, a UAV docking apparatus is present. The apparatus may include a UAV docking station that includes a landing surface upon which a UAV lands, a first plurality of electrical contacts positioned on the landing surface such that a second plurality of electrical contacts of a UAV physically contact the first plurality of electrical contacts when the UAV is positioned upon the landing surface, an on-board power storage component that supplies power to at least one electrical contact of the first plurality of electrical contacts, and a visual alignment pattern on the landing surface for imaging by the UAV.

Embodiments of the UAV docking apparatus may include one or more of the following features: The docking station may include an engagement circuit that electrically connects and electrically disconnects the second plurality of contacts from the on-board power storage component of the UAV docking system. The docking station may include a battery charge monitor that occasionally performs a measurement of an electrical condition of the on-board power storage component of the UAV and the battery charge monitor is configured to enable and disable charging of the on-board power storage component by a power source of the UAV docking station based on the measurement of the electrical condition while the UAV is positioned on the landing surface. The visual alignment pattern may include a plurality of colored patches arranged along a periphery of the landing surface.

In some embodiments, a method for charging an unmanned aerial vehicle (UAV) may be present. The method may include travelling, by the UAV, to a vicinity of a UAV docking station based on global navigation satellite system (GNSS) based navigation. The method may include identifying the UAV docking station based on image recognition of an alignment graphic on a docking platform of the UAV docking station. The method may include determining, by the UAV, a landing rotational orientation based on the image recognition. The method may include rotating, by the UAV, to the landing rotational orientation. The method may include landing the UAV on the docking platform of the UAV docking station in the landing rotational orientation such that a first plurality of electrical connectors of the UAV electrically connect with a second plurality of electrical connectors of the UAV docking station.

Embodiments of such a method may include one or more of the following features: While the UAV is landed on the docking platform of the UAV docking station, gravity may cause the first plurality of electrical connectors of the UAV to physically contact the second plurality of electrical connectors of the UAV docking station. The method may include initiating charging of a power storage component of the UAV via the first plurality of electrical connectors and the second plurality of electrical connectors based on sensing that a first electrical connector of the first plurality of electrical connectors is in physical contact with a designated second electrical connector of the second plurality of electrical connectors. The method may include after initiating charging, disabling charging of the power storage component of the UAV based on a battery charge monitor determining that a first threshold charge condition has been satisfied. The method may include after disabling charging, reinitiating charging while the UAV remains positioned on the UAV docking station based on the battery charge monitor determining that a second threshold charge condition has been satisfied.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an embodiment of a UAV docking system that includes a UAV and a UAV docking station.

FIG. 2 illustrates an embodiment of a block diagram of a UAV.

FIG. 3 illustrates an embodiment of a block diagram of a UAV docking station.

FIG. 4 illustrates an embodiment of a method for landing and charging a UAV using a UAV docking station.

FIG. 5 illustrates an embodiment of a method for occasionally reactivating charging of a power source of a UAV while docked with a UAV docking station.

FIG. 6 illustrates an embodiment of a computer system that may be incorporated as part of the UAV and/or UAV docking station.

### DETAILED DESCRIPTION

A UAV may, based on a distance travelled from its docking station and an amount of charge remaining in an on-board power source, may determine to return to the docking station for recharging of the power source. The UAV may plot a course to the UAV docking station. This course may, for example, retrace previous travel of the UAV, be a new, more direct route to the docking station that avoids obstacles, or may be a direct path to the docking station. The UAV docking system may include components present on the UAV and on the docking station that enables the UAV to land on a docking platform of the docking station in a particular orientation that enables recharging of a power source of the UAV. A UAV docking station may include multiple pads or zones on a docking platform for the UAV. A visual graphic or pattern many be visible on a top surface of the docking platform. This visual graphic or pattern may allow image recognition componentry of the UAV to analyze the visual graphic or pattern to align and orient the UAV prior to landing. As the UAV descends towards the docking platform, the graphic or pattern may continue to be analyzed such that proper alignment and orientation between the UAV and the docking platform is maintained.

Upon landing, when the UAV is in proper alignment and orientation relative to the UAV docking platform, multiple electrical contacts of the UAV may contact electrical contacts of the UAV docking platform. When componentry of the UAV docking station senses that the proper electrical connections have been formed, charging of a power source (e.g., one or more batteries and/or capacitors) of the UAV may commence. After a time, charging may be determined to be sufficient or complete and the UAV may take off from the UAV docking platform using its propulsion system. The entire charging process may be performed without a user physically manipulating any component of the UAV or UAV docking station. Therefore, the UAV can either operate autonomously or be controlled exclusively by a remote user having no direct physical interaction with the UAV and UAV docking station.

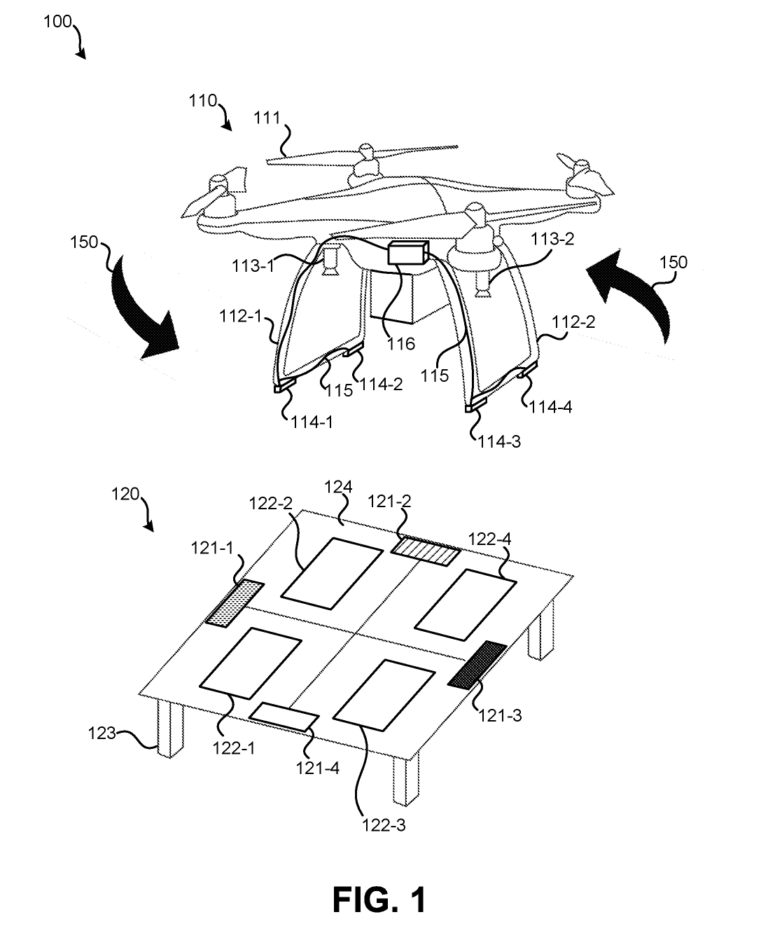

FIG. 1 illustrates an embodiment of a UAV docking system 100 that includes a UAV 110 and a UAV docking station 120. UAV 110 may include rotors 111 that provide for lift and can be controlled to adjust the UAV's flight path and ascent and descent. UAV 110 may include support structure 112 (112-1, 112-2) which may include multiple rails that allow UAV 110 to land on various surfaces, including the surface of UAV docking station 120. UAV 110 may additionally include: cameras 113, electrical contacts 114, electrical wiring 115, and power source 116 (which can also be referred to as an on-board power storage component).

One or more cameras 113 (113-1, 113-2) may be attached with UAV 110 such that the one or more cameras' fields-of-view are aimed below UAV 110, allowing objects directly below UAV 110 to be imaged by cameras 113 when UAV 110 is hovering or descending. Cameras 113 may be communicatively coupled with one or more processors and memory that allow images captured by camera 113 to be analyzed and used to direct hovering and flight of UAV 110. Camera 113 may be a visible light camera and/or an infrared camera. In some embodiments, a single camera is present.

Multiple electrical contacts 114 (e.g., 114-1, 114-2, 114-3, and 114-4) may be attached with a lower side of support structure 112 such that when UAV 110 lands on a roughly flat surface, such as a docking platform, electrical contacts 114 will be in physical contact with the surface of the docking platform. While on the docking platform, gravity and friction can help maintain physical contact between electrical contacts 114 and the surface of the docking platform. Electrical contacts 114 may be conductive pieces of metal that are permanently or removably attached with support structure 112. In some embodiments, electrical contacts 114 may be or include magnets that allow for magnetic coupling with metallic or magnetic components of the docking station. In some embodiments, rather than electrical contacts 114 requiring a direct electrical connection with electrical contacts of UAV docking station 120 in order to receive a signal, inductive charging components may be used, thus allowing for charging to occur over a relatively short distance.

Electrical contacts 114 may be connected with power source 116 and/or control circuitry of UAV 110 via wiring 115. Separate wiring for each electrical contact of electrical contacts 114 may be present. As such, each electrical contact 114 may be used independently, such as electrical contact 114-1 for power, electrical contact 114-2 for ground, and electrical contacts 114-3 and 114-4 for communication signals.

Power source 116 can represent an internal or external power source of UAV 110, such as one or more batteries and/or one or more capacitors. Power source 116 may receive charge via electrical contacts 114 and wiring 115. Power source 116 may serve to power at least the propulsion system that drives rotors 111.

Power source 116, wiring 115, and electrical contacts 114 may be an add-on kit that can be installed by a user separate from the manufacturing of UAV 110. That is, a user, who desires to convert a UAV from using a conventional charging arrangement that requiring user intervention to charge power source 116 may attach electrical contacts 114, wiring 115, and, possibly, power source 116 to allow for autonomous charging without user intervention. In other embodiments, these components may be incorporated as part of UAV 110 as part of manufacturing of UAV 110.

UAV docking station 120 may include: docking platform (or pad) 124, landing pad platform orientation and alignment indicators 121 (which include platform orientation and alignment indicators 121-1, 121-2, 121-3, and 121-4), electrical contacts 122 (which can include electrical contacts 122-1, 122-2, 122-3, and 122-4), and docking platform supports (such as docking platform support 123). Docking platform 124 may be sized to accommodate a UAV, such as UAV 110. In other embodiments, a landing pad may be sized to accommodate multiple UAVs simultaneously.

Platform orientation and alignment indicators 121 represent machine-readable codes that can be imaged from above docking platform 124 by a hovering UAV, such as UAV 110. Platform orientation and alignment indicators 121 may be in the form of differently colored blocks, which is illustrated in FIG. 1. In the illustrated embodiment, each side of the docking platform 124 is associated with a different color block. UAV 110 may align and orient itself while hovering relative to platform orientation and alignment indicators 121. Based on platform orientation and alignment indicators 121, UAV 110 can determine a distance from docking platform 124, an alignment with docking platform 124, and/or an orientation relative to docking platform 124. In addition to color blocks, other forms of graphical identifiers may be used, such as QR-codes, text, a graphical picture, or, in some embodiments, the shape or periphery of docking platform 124.

Electrical contacts 122 may be distributed across the surface of docking platform 124. Each of electrical contacts 122 may be electrically distinct from each other, thus allowing each of electrical contacts 122 to be used for separate purposes. Electrical contacts 122 may each correspond to an electrical contact of electrical contacts 114. Therefore, for example, electrical contact 122-1 may be connected with power of a power source of UAV docking station 120, electrical contact 122-2 may be connected with a ground, and electrical contacts 122-3 and 122-4 may be connected with a communication component of UAV docking station 120. Electrical contacts 122 may be larger in size than electrical contacts 114 therefore allowing for a margin of error when UAV 110 lands on docking platform 124 while still allowing for proper electrical connection between electrical contacts 114 and electrical contacts 122. Electrical contacts 122 may be conductive metallic pads that allow for an electrical connection with electrical contacts 114 when in direct physical contact. In other embodiments, rather than electrical contacts 122 being present on the surface of docking platform 124, inductive componentry may be embedded or below docking platform 124 that allows for power and signals to be exchanged with corresponding componentry of UAV 110. It should be understood that the number of electrical contacts on docking platform 124 and the number of electrical contacts on UAV 110 are merely exemplary, fewer or greater numbers of electrical contacts may be present in other embodiments.

In some embodiments, one or more magnets may be used as electrical contacts 122 or may be separately distributed on or under the surface of docking platform 124. Such magnets may help with alignment by magnetically engaging with metallic components or other magnets of UAV 110. For instance, if both UAV 110 and UAV docking station 120 use magnets for electrical contacts, magnetic attraction may help initially couple and then hold UAV 110 in a position with proper alignment on docking platform 124.

Rotational arrows 150 are indicative of UAV 110 being configured to rotate and orient in relation to platform orientation and alignment indicators 121 such that electrical contacts 114 aligned with the corresponding electrical contacts 122. However, it should be understood that in other embodiments, electrical contacts 114 and/or electrical contacts 122 may be configurable based on a determined landing orientation of UAV 110. Therefore, which electrical contact of electrical contacts 122 supplies or receives power, ground, and/or communication signals may be modified to adjust to a landing orientation of UAV 110, potentially eliminating the need for UAV 110 to lands in a particular orientation.

Support 123 may serve to elevate docking platform 124 a distance above a floor or the ground. Support 123, of which there may be four (similar to a typical table), may be of different lengths if docking platform 124 is to be elevated above uneven ground. Support 123 and docking platform 124 may be made of a rigid material such as plastic, metal, or wood.

In some embodiments, platform orientation and alignment indicators 121 and electrical contacts 122 may be added, along with charging circuitry, to convert a conventional landing platform, table, or other flat surface into a docking platform that allows for autonomous charging of UAV 110. For example, a user may attach electrical contacts 122 to a flat surface and place platform orientation and alignment indicators in relation to electrical contacts 122. Along with the addition of charging circuitry, may effectively convert the flat surface into a UAV docking station 120 capable of recharging UAV 110 without user intervention.

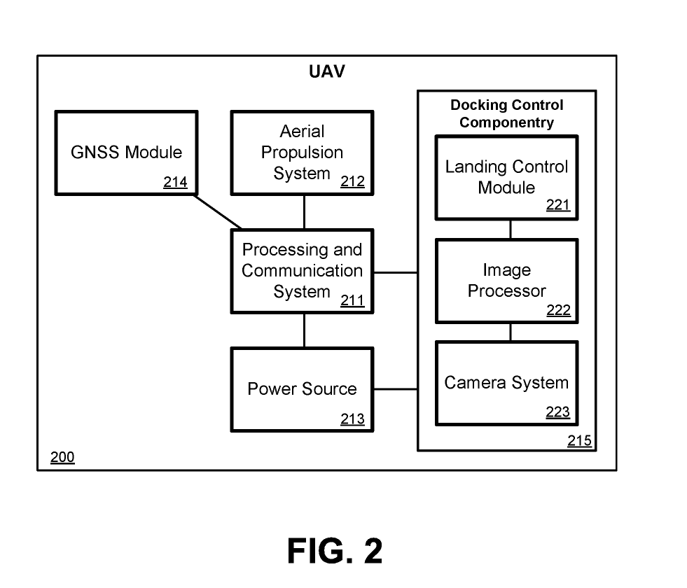

FIG. 2 illustrates an embodiment of a block diagram of a UAV 200. UAV 200 can represent a block diagram of UAV 110 of FIG. 1. UAV 200 may include: processing and communication system 211, aerial propulsion system 212, power source 213, GNSS module 214, and docking control componentry 215.

Aerial propulsion system 212 may be one or more rotors that are used to provide lift for UAV 200 and control the flight path of UAV 200. Power source 213 (also referred to as an on-board power storage component), which can include one or more batteries and/or capacitors are present on UAV 200. Power source 213 may serve as the primary source of power for other components of UAV 200. For instance, power source 213 may provide the power for aerial propulsion system 212 to lift UAV 200 into the air. A GNSS (Global Navigation Satellite System) module, which may be a GPS (Global Positioning System) module, may be used for positioning and navigation following a take-off procedure of UAV 200 being performed and prior to a landing procedure of UAV 200 being performed.

Docking control componentry 215 may include multiple components, including: landing control module 221, image processor 222, and camera system 223. Landing control module 221 may be a subsystem of processing and communication system 211. Landing control module 221 may monitor how far UAV 200 is from an associated docking station and may monitor a remaining amount of charge of power source 213. While maintaining a margin of safety, landing control module 221 may initiate travel along a flightpath to travel to or return to the docking station based on the distance of the UAV from the docking station and/or the remaining amount of charge of power source 213. Landing control module 221 may be configured to follow a straight path to the docking station, retrace a previous flightpath to the docking station, or plot in alternate route that avoids obstacles to the docking station. In some embodiments, a user may be instructed to fly UAV 200 to the docking station in the flightpath may be determined by the user.

Camera system 223 may include one or more cameras that image visible or infrared light. Camera system 223 may be mounted on or attached with UAV 200 such that a field of view of camera system 223 includes a region below UAV 200. Therefore, as UAV 200 is hovering roughly above a docking platform, camera system 223 may be able to image the docking platform. In some embodiments, one or more cameras of camera system 223 may be swivel mounted such that a field of view of the camera can be set independent of an orientation of UAV 200. Therefore, a camera that may be used for photography or videography while UAV 200 is in flight, may be used as part of docking control componentry 215 during a landing procedure.

Image processor 222 may receive images from camera system 223. Image processor 222 may analyze images obtained from camera system 223 to attempt to identify platform orientation and alignment indicators that are expected to be present on or in relation to a docking platform in the general area. Image processor 222 may be able to determine a distance, in alignment, and in orientation of UAV 200 in relation to the platform orientation and alignment indicators. Image processor 222 may pass such information to landing control module 221. Based on the status, landing control module 221 may control the altitude, position, and orientation of UAV 200. Landing control module 221, when the alignment, orientation, and position of the UAV 200 is appropriate in relation to the docking platform, may initiate and control a dissent of UAV 200. Data may continue to be fed from image processor 222 to landing control module 221 such that any adjustments in relation to position, alignment, or orientation of UAV 200 can be performed during the descent or prior to UAV 200 touching down on the docking platform.

Processing and communication system 211 can represent one or more processors and one or more wired or wireless communication interfaces. Processing and communication system 211 may communicate with GNSS module 214, power source 213, docking control componentry 215, and aerial propulsion system 212. Processing and communication system 211 may include one or more wireless communication interfaces that allows UAV 200 to communicate with a remote system, such as a remote computerized system operated by a pilot of UAV 200. One or more wired communication interfaces may allow UAV 200 to communicate with componentry of a UAV docking station via electrical contacts when docked. Processing and communication system 211 may control propulsion of the UAV via aerial propulsion system 212 and may transmit or otherwise use location information from GNSS module 214. Processing and communication system 211 may communicate with docking control componentry 215. In some embodiments, landing control module 221 is a separate processing component from processing and communication system 211; in other embodiments, landing control module 221 may be firmware or a software routine that is executed by processing and communication system 211.

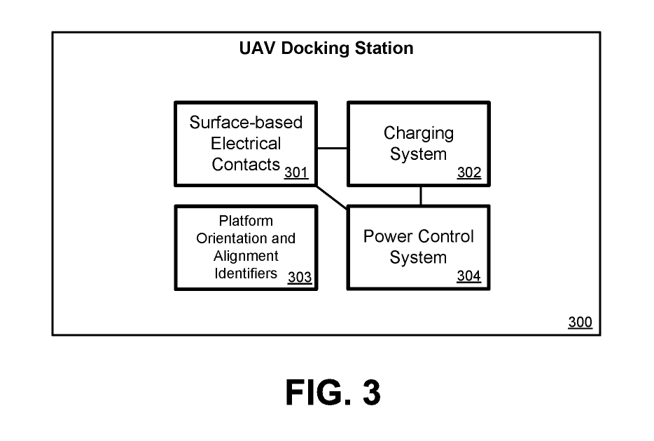

FIG. 3 illustrates an embodiment of a block diagram of a UAV docking station 300. UAV docking station 300 can represent UAV docking station 120 of FIG. 1. UAV docking station 300 can represent a docking station with which UAV 200 of FIG. 2 can dock and recharge power source 213 without physical manipulation by a person or user.

UAV docking station 300 may include: surface-based electrical contacts 301, charging system 302, platform orientation and alignment indicators 303, and power control system 304. Surface-based electrical contacts 301 may be electrically distinct contacts that are each connected with charging system 302 and/or power control system 304. Each of surface-based electrical contacts 301 may serve distinct purposes, such as serving as a connection with the UAV for power, ground, or a communication signal. In some embodiments, more than one contact may be used for the same purpose, such as serving as a ground connection.

Charging system 302 may serve to output power to surface-based electrical contacts 301 when activated by power control system 304. Charging system 302 may include a connection with an external power source, such as an AC-based electrical grid or possibly, a battery of UAV docking station 300 that is charged by another source, such as solar panels. Charging system 302 may plug into a standard household outlet to obtain power for use in charging a power source of a UAV. Charging system 302 may include an AC to DC converter, a DC step up or step down converter, a current regulator, and/or other power systems that facilitate charging of a power source of a UAV. Charging system 302 may be activated and deactivated by power control system 304.

Power control system 304, which may be integrated with charging system 302, may only activate charging system 302 when a UAV is properly connected with surface-based electrical contacts 301. In some embodiments, power control system 304 has circuitry that monitors for a particular electrical contact or electrical contacts of surface-based electrical contacts 301 being in contact with a corresponding electrical contact of the UAV. For example, one or more electrical contacts associated with a communication signal may first be checked for proper connection with the UAV by an electrical loop being closed or a messaging signal being properly received and responded to via the electrical contacts. When electrical contacts of the UAV are properly in contact with electrical contacts of surface-based electrical contacts 301, power control system 304 may have circuitry that analyzes a charge level of a power source of the UAV. If charging is needed (e.g., based on a measured voltage of the UAV's on-board power storage component), power control system 304 may activate charging system 302 such that power flows from charging system 302 through surface-based electrical contacts 301 to charge the UAV's on-board power storage component.

Platform orientation alignment identifiers 305 may be attached with a surface of the docking platform of UAV docking station 300. In some embodiments, platform orientation and alignment indicators 303 are colored blocks, possibly of a particular size, for which an image processing system of the UAV has been configured to monitor. Platform orientation and alignment indicators 303 may be spaced a defined distance from each other and may at least partially outline a periphery of the docking platform.

Surface-based electrical contacts 301 may be connected with power control system 304 and charging system 302 via wires. If the user is creating UAV docking station 300 from a conventional docking platform or another flat surface, such as a table, surface-based electrical contacts 301 may be attached to the surface of the docking platform in a designated pattern and spacing with wires to charging system 302 and power control system 304. Similarly, platform orientation in alignment indicators 303 may be attached to the surface of the docking platform in another designated pattern and spacing. Charging system 302 and/or power control system 304 may then be coupled with a power source, such as a household outlet connected with the electrical grid or a renewable power source, such as solar panels. Recharging of a UAV via a UAV docking station 300 may then be performed without physical intervention by a person. In other embodiments, UAV docking station 300 may be manufactured with electrical contacts 301, charging system 302, platform orientation and alignment indicators 303, and power control system 304 incorporated.

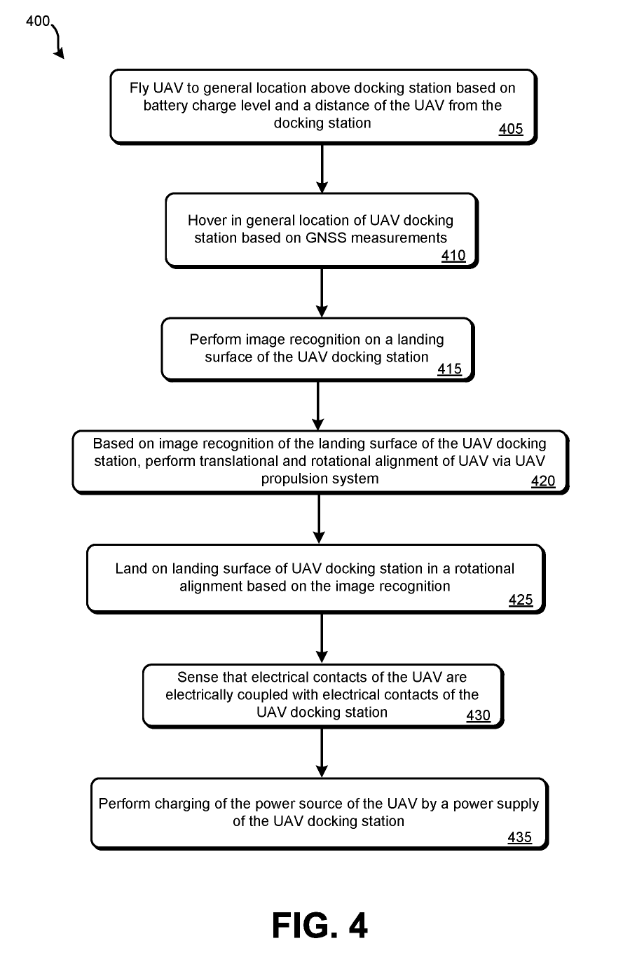

Using the systems detailed in relation to FIGS. 1-3, various methods may be performed. FIG. 4 illustrates an embodiment of a method for landing and charging a UAV using a UAV docking station. Method 400 may be performed using the UAV docking systems detailed in relation to FIGS. 1-3. Generally, method 400 may be understood to be a landing procedure for landing a UAV on a UAV docking station and charging a power source of the UAV without a person physically intervening or participating in the process.

At block 405, the UAV may fly to a general location above the UAV docking station. Block 405 may be triggered based on a battery charge level and/or the distance of the UAV from the docking station. That is, the farther the UAV is from the docking station the higher the battery charge level may be when flight to the docking station is initiated. Accordingly, a UAV with a low charge level may remain flying longer closer to the docking station than if the UAV was a farther distance from the docking station. Navigation back to the docking station may be based on GNSS positioning. Typically, such a satellite-based positioning is accurate to within 5 to 10 feet, which may not be accurate enough for the UAV to land on a docking platform of the UAV docking station.

At block 410, the UAV may hover in the general location of the UAV docking station. Once hovering, rather than landing on the UAV docking station based on GNSS measurements, image recognition of a pattern on the docking platform of the UAV docking station may be used as the primary guide for landing the UAV. At block 415, image recognition using a camera an image processor of the UAV may be performed on the landing surface or docking platform of the UAV docking station. The image recognition process may attempt to recognize platform orientation and alignment indicators, such as of colored blocks.

At block 420, based on image recognition of the platform orientation and alignment indicators, the hovering of the UAV may be adjusted. This may include both translational and rotational alignment of the UAV relative to the platform orientation and alignment indicators. At block 425, the UAV may descend and land on the landing surface of the UAV in a proper rotational alignment based on image recognition of the platform orientation and alignment indicators.

At block 430, the UAV docking station, the UAV, or both may sense whether the electrical contacts of the UAV are properly electrically coupled with corresponding electrical contacts of the UAV docking station. This may be performed by a circuit being completed via the electrical contacts or the ability for the UAV docking station and UAV to exchange a communication signal or message. In response to determining that the electrical contacts of the UAV and the UAV docking station are in contact and properly correspond, charging of the power source of the UAV via a power supply of the UAV docking station may be performed via the electrical connections formed through the electrical contacts.

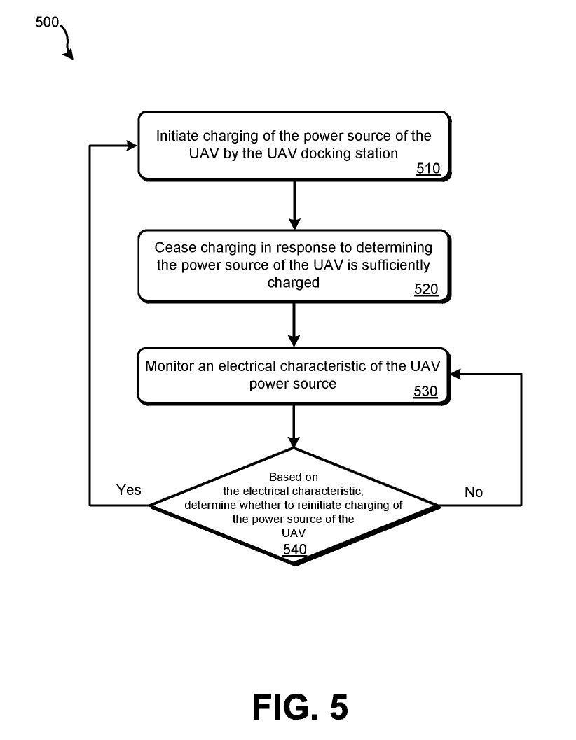

If a UAV lands on a UAV docking station, has its power source charged, and remains resting on the docking station for a long enough duration, the power source may again need to charged. FIG. 5 illustrates an embodiment of a method 500 for occasionally reactivating charging of a power source of a UAV while docked with a UAV docking station. Method 500 may be performed as part of block 435 of method 400.

At block 510, charging of the power source of the UAV may be initiated. Initiation of the charging may be based on an electrical characteristic of the power source being below a particular threshold, such as a threshold voltage. Once the power source is been sufficiently charged, charging may be stopped at block 520, such as by power control system 304, in response to an electrical characteristic of the power source being above the same or different, higher threshold, such as a second, higher threshold voltage.

At block 530, and electrical characteristic of the UAV power source may be occasionally monitored. For example, the voltage level of the UAV power source may be checked. At block 540, based on a measurement of the electrical characteristic at block 530, a determination may be made whether to reinitiate charging of the power source of the UAV. Again here, this determination may be based on a threshold comparison. If the determination is yes, method 500 may proceed to block 510. If no, method 500 may proceed to block 530.

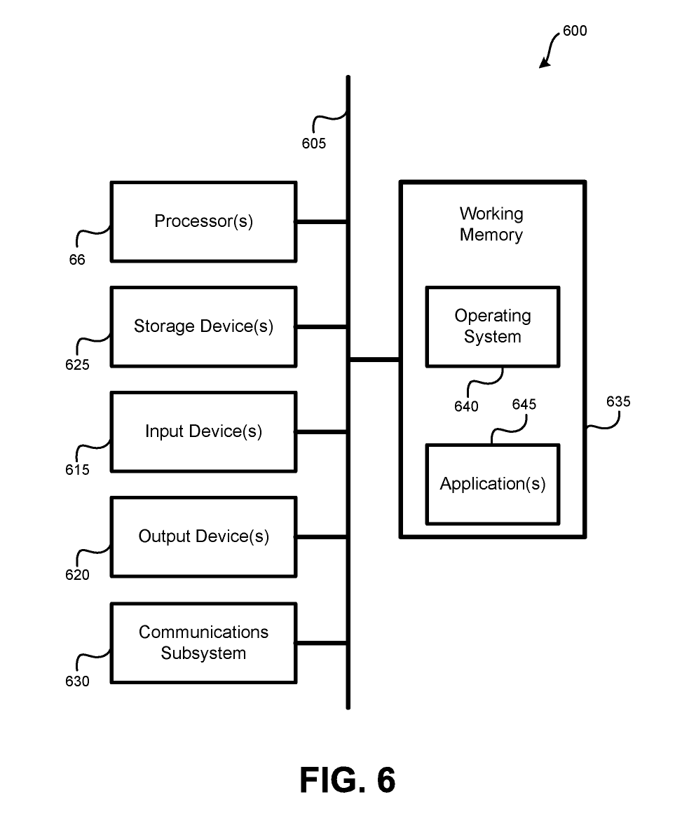

FIG. 6 illustrates an embodiment of a computer system that may be incorporated as part of the UAV and/or UAV docking station. A computer system as illustrated in FIG. 6 may be incorporated as part of the previously described computerized devices, such as UAV 110, UAV docking station 120, and/or a remote computerized system that controls and/or communicates with UAV 110 and/or UAV docking station 120. FIG. 6 provides a schematic illustration of one embodiment of a computer system 600 that can perform various steps of the methods provided by various embodiments. It should be noted that FIG. 6 is meant only to provide a generalized illustration of various components, any or all of which may be utilized as appropriate. FIG. 6, therefore, broadly illustrates how individual system elements may be implemented in a relatively separated or relatively more integrated manner.

The computer system 600 is shown comprising hardware elements that can be electrically coupled via a bus 605 (or may otherwise be in communication). The hardware elements may include one or more processors 610, including without limitation one or more general-purpose processors and/or one or more special-purpose processors (such as digital signal processing chips, graphics acceleration processors, video decoders, and/or the like); one or more input devices 615, which can include without limitation a mouse, a touchscreen, keyboard, remote control, and/or the like; and one or more output devices 620, which can include without limitation a display device, a printer, etc.

The computer system 600 may further include (and/or be in communication with) one or more non-transitory storage devices 625, which can comprise, without limitation, local and/or network accessible storage, and/or can include, without limitation, a disk drive, a drive array, an optical storage device, a solid-state storage device, such as a solid state drive (“SSD”), random access memory (“RAM”), and/or a read-only memory (“ROM”), which can be programmable, flash-updateable and/or the like. Such storage devices may be configured to implement any appropriate data stores, including without limitation, various file systems, database structures, and/or the like.

The computer system 600 might also include a communications subsystem 630, which can include without limitation a modem, a network card (wireless or wired), an infrared communication device, a wireless communication device, and/or a chipset (such as a Bluetooth™ device, BLE, an 802.11 device, an 802.15.4 device, a WiFi device, a WiMax device, cellular communication device, etc.), and/or the like. The communications subsystem 630 may permit data to be exchanged with a network (such as the network described below, to name one example), other computer systems, and/or any other devices described herein. In many embodiments, the computer system 600 will further comprise a working memory 635, which can include a RAM or ROM device, as described above.

The computer system 600 also can comprise software elements, shown as being currently located within the working memory 635, including an operating system 640, device drivers, executable libraries, and/or other code, such as one or more application programs 645, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the non-transitory storage device(s) 625 described above. In some cases, the storage medium might be incorporated within a computer system, such as computer system 600. In other embodiments, the storage medium might be separate from a computer system (e.g., a removable medium, such as a compact disc), and/or provided in an installation package, such that the storage medium can be used to program, configure, and/or adapt a general purpose computer with the instructions/code stored thereon. These instructions might take the form of executable code, which is executable by the computer system 600 and/or might take the form of source and/or installable code, which, upon compilation and/or installation on the computer system 600 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 600) to perform methods in accordance with various embodiments of the invention. According to a set of embodiments, some or all of the procedures of such methods are performed by the computer system 600 in response to processor 610 executing one or more sequences of one or more instructions (which might be incorporated into the operating system 640 and/or other code, such as an application program 645) contained in the working memory 635. Such instructions may be read into the working memory 635 from another computer-readable medium, such as one or more of the non-transitory storage device(s) 625. Merely by way of example, execution of the sequences of instructions contained in the working memory 635 might cause the processor(s) 610 to perform one or more procedures of the methods described herein.

The terms “machine-readable medium,” “computer-readable storage medium” and “computer-readable medium,” as used herein, refer to any medium that participates in providing data that causes a machine to operate in a specific fashion. These mediums may be non-transitory. In an embodiment implemented using the computer system 600, various computer-readable media might be involved in providing instructions/code to processor(s) 610 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the non-transitory storage device(s) 625. Volatile media include, without limitation, dynamic memory, such as the working memory 635.

Common forms of physical and/or tangible computer-readable media include, for example, a floppy disk, a flexible disk, hard disk, magnetic tape, or any other magnetic medium, a CD-ROM, any other optical medium, any other physical medium with patterns of marks, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 610 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 600.

The communications subsystem 630 (and/or components thereof) generally will receive signals, and the bus 605 then might carry the signals (and/or the data, instructions, etc. carried by the signals) to the working memory 635, from which the processor(s) 610 retrieves and executes the instructions. The instructions received by the working memory 635 may optionally be stored on a non-transitory storage device 625 either before or after execution by the processor(s) 610.

It should further be understood that the components of computer system 600 can be distributed across a network. For example, some processing may be performed in one location using a first processor while other processing may be performed by another processor remote from the first processor. Other components of computer system 600 may be similarly distributed. As such, computer system 600 may be interpreted as a distributed computing system that performs processing in multiple locations. In some instances, computer system 600 may be interpreted as a single computing device, such as a distinct laptop, desktop computer, or the like, depending on the context.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A unmanned aerial vehicle (UAV) docking system, comprising:
a UAV, comprising:
a propulsion system;
an on-board power storage component;
a support structure; and
a first plurality of electrical contacts electrically connected with the on-board power storage component and attached with a lower portion of the support structure; and
a UAV docking station, comprising:
a landing platform upon which the UAV lands;
a second plurality of electrical contacts positioned on the landing platform such that the first plurality of electrical contacts of the UAV physically contact the second plurality of electrical contacts when the UAV has landed upon the landing platform; and
a power source that supplies power to at least one electrical contact of the second plurality of electrical contacts.

2. The UAV docking system of claim 1, wherein the UAV docking station further comprising a visual alignment pattern on the landing platform.

3. The UAV docking system of claim 2, wherein the UAV further comprises:
an imaging sensor that is positioned on the UAV to image a field-of-view below the support structure of the UAV; and
an imaging processor that receives imaging data from the imaging sensor, wherein imaging processor is configured to control the propulsion system of the UAV to rotationally align the UAV with respect to the visual alignment pattern on the landing platform of the UAV docking station.

4. The UAV docking system of claim 2, wherein the visual alignment pattern comprises a plurality of colored patches.

5. The UAV docking system of claim 1, wherein:
the first plurality of electrical contacts comprises: a UAV power electrical contact, a UAV ground electrical contact, and a UAV signal electrical contact; and
the second plurality of electrical contacts comprises: a docking station power electrical contact, a docking station ground electrical contact, and a docking station signal electrical contact.

6. The UAV docking system of claim 1, wherein the UAV docking station further comprises an engagement circuit that electrically connects and electrically disconnects the second plurality of contacts from the power source of the UAV docking system.

7. The UAV docking system of claim 1, wherein:
the support structure comprises a first rail and a second rail, wherein the first rail is parallel to the second rail; and
at least a first electrical contact and a second electrical contact of the first plurality of electrical contacts are attached with the first rail such that when the UAV is positioned on the UAV docking station, the first electrical contact and the second electrical contact of the first plurality of electrical contacts physically contact a first electrical contact and a second electrical contact of the second plurality of electrical contacts.

8. The UAV docking system of claim 1, wherein the UAV docking station further comprises:
a battery charge monitor that occasionally performs a measurement of an electrical condition of the on-board power storage component of the UAV and the battery charge monitor is configured to enable and disable charging of the on-board power storage component by the power source of the UAV docking station based on the measurement of the electrical condition while the UAV is positioned on the landing platform.

9. The UAV docking system of claim 1, wherein the on-board power storage component is charged without any direct physical manipulation by a person.

10. A unmanned aerial vehicle (UAV) docking apparatus, comprising:
a UAV, comprising:
a propulsion system;
an on-board power storage component;
a support structure;
a first plurality of electrical contacts electrically connected with the on-board power storage component and attached with a lower portion of the support structure;
an imaging sensor that is positioned on the UAV to image a field-of-view below the support structure; and
an imaging processor that receives imaging data from the imaging sensor, wherein imaging processor is configured to control the propulsion system of the UAV to rotationally align the UAV with respect to a visual alignment pattern on a landing surface of a UAV docking station.

11. The UAV docking apparatus of claim 10, wherein:
the support structure comprises a first rail and a second rail, wherein the first rail is parallel to the second rail; and
at least a first electrical contact and a second electrical contact of the first plurality of electrical contacts are attached with the first rail such that when the UAV is positioned on the UAV docking station, the first electrical contact and the second electrical contact of the first plurality of electrical contacts physically contact a first electrical contact and a second electrical contact of the second plurality of electrical contacts.

12. A UAV docking apparatus, comprising:
a UAV docking station, comprising:
a landing surface upon which a UAV lands;
a first plurality of electrical contacts positioned on the landing surface such that a second plurality of electrical contacts of a UAV physically contact the first plurality of electrical contacts when the UAV is positioned upon the landing surface;
an on-board power storage component that supplies power to at least one electrical contact of the first plurality of electrical contacts; and
a visual alignment pattern on the landing surface for imaging by the UAV.

13. The UAV docking apparatus of claim 12, wherein the UAV docking station further comprises an engagement circuit that electrically connects and electrically disconnects the second plurality of contacts from the on-board power storage component of the UAV docking system.

14. The UAV docking apparatus of claim 13, wherein the UAV docking station further comprises:
a battery charge monitor that occasionally performs a measurement of an electrical condition of the on-board power storage component of the UAV and the battery charge monitor is configured to enable and disable charging of the on-board power storage component by a power source of the UAV docking station based on the measurement of the electrical condition while the UAV is positioned on the landing surface.

15. The UAV docking apparatus of claim 14, wherein the visual alignment pattern comprises a plurality of colored patches arranged along a periphery of the landing surface.

16. A method for charging an unmanned aerial vehicle (UAV), the method comprising:
travelling, by the UAV, to a vicinity of a UAV docking station based on global navigation satellite system (GNSS) based navigation;
once flying in the vicinity of the UAV docking station, identifying the UAV docking station based on image recognition of an alignment graphic on a docking platform of the UAV docking station;
determining, by the UAV, a landing rotational orientation based on the image recognition;
rotating, by the UAV, to the landing rotational orientation; and
landing the UAV on the docking platform of the UAV docking station in the landing rotational orientation such that a first plurality of electrical connectors of the UAV electrically connect with a second plurality of electrical connectors of the UAV docking station.

17. The method for charging the UAV of claim 16, wherein while the UAV is landed on the docking platform of the UAV docking station, gravity causes the first plurality of electrical connectors of the UAV to physically contact the second plurality of electrical connectors of the UAV docking station.

18. The method for charging the UAV of claim 17, further comprising:
initiating charging of a power storage component of the UAV via the first plurality of electrical connectors and the second plurality of electrical connectors based on sensing that a first electrical connector of the first plurality of electrical connectors is in physical contact with a designated second electrical connector of the second plurality of electrical connectors.

19. The method for charging the UAV of claim 18, further comprising:
after initiating charging, disabling charging of the power storage component of the UAV based on a battery charge monitor determining that a first threshold charge condition has been satisfied; and
after disabling charging, reinitiating charging while the UAV remains positioned on the UAV docking station based on the battery charge monitor determining that a second threshold charge condition has been satisfied.

20. The method for charging the UAV of claim 18, wherein a person does not physically touch the UAV from travelling until at least initiating charging.
